(19) United States
(12) Patent Application Publication
(10) Pub. No.: US 2015/0193840 A1
(43) Pub. Date: Jul. 9, 2015

(54) CUSTOMER CONTEXT ANALYSIS AGENT COMMUNICATION AID

(71) Applicant: BANK OF AMERICA CORPORATION, Charlotte, NC (US)

(72) Inventors: Gopi Krishna Punukollu, Hyderabad (IN); Srikanth Reddy Komma, Hyderabad (IN)

(73) Assignee: BANK OF AMERICA CORPORATION, Charlotte, NC (US)

(21) Appl. No.: 14/149,264

(22) Filed: Jan. 7, 2014

(51) Int. Cl. G06Q 30/02

(52) U.S. Cl. CPC G06Q 30/0281; G06Q 30/0255; G06Q 40/02

(57) ABSTRACT

Embodiments of the invention are directed to a system, method, or computer program product for providing an agent communication aid based on customer context analysis, such that the agent or communication channel can more effectively assist a customer. As such, the system may provide a customer context profile associated with the customer to the channel. The profile compiles event data associated with the customer from online, inquiry, transactional, status, or external sources. Subsequently, this data is processed through rules and logic to provide real-time data associated with prior customer communications via the customer context profile. Furthermore, the system may predict one or more reasons for future customer communications and provided options for the customer's communications. Thus, providing the agent or communication channel with a customer context profile with a holistic view of the customer prior to a future customer communication.

### BACKGROUND

Customers typically have a variety of options when communicating with entities such as financial institutions. A customer may have one or more ways he/she prefers to communicate with the financial institution, such as calling the financial institution, online, mobile, automatic teller machine (ATM), or at a brink-and-mortar location. When a customer communicates with a financial institution, the financial institution wants to assist that customer as quickly as possible. As such, providing fast, accurate customer service to the customer when the customer communicates with the financial institution.

### BRIEF SUMMARY

Embodiments of the present invention address the above needs and/or achieve other advantages by providing apparatuses (e.g., a system, computer program product and/or other devices) and methods for providing an agent communication aid based on customer context analysis, such that the agent can more effectively assist a customer.

A customer may wish to communicate with an entity, such as a financial institution. The customer communication may be for one or more reasons such as to complete a transaction, conduct business, a question, a dispute, or the like. Furthermore, the customer may be able to communicate with the entity via several different means or channels of communication. These may include online or offline communication channels. Online communication channels may include one or more of communications via a website, application, chatting, email, or the like. Offline communication channels may include the customer going to a store location, an ATM, or the like. With several different locations and channels for a customer to communicate with the entity, it is important that the entity monitors and knows why the customer has communicated with the entity in the past. As such, this invention provides an agent communication aid that is based on a customer context analysis, this way the agent or channel may be in a better position to provide customer service upon customer communications.

In some embodiments, customer context analysis includes an analysis of customer event data. This event data may include online data, inquiry data, account status data, customer status data, transactional data, and/or external events data. This data may be provided to the system in real-time such that the system may have up to the minute data associated with the customer and his/her communications with the financial institution.

In some embodiments, the system may then process the events in real-time to incorporate into an updated customer context profile, updating model data, and/or updating offers. In some embodiments, updated customer context profile, updating model data, and/or updating offers allows the system to predict reasons for future communications, modulate communications based on the predicted reason for future communications, recommend more appropriate channels for future communications, determine talking points, or the like to provide improved customer support.

Predicting one or more reasons why the customer may attempt to communicate with the entity in the future allows the system to prepare the agent for customer interaction and allows for improved customer service. Predicting one or more reasons why the customer will be communicating with the entity in the future is determined by event data collected from above. This includes event data about previous communications, including the date, time, channel, reason, and outcome for each of the previous communications. The data comprised about previous communications allows the system to predict a routine associated with customer communications and the like. Furthermore, event data may also include one or more transaction a customer may have made. These transactions may include one or more purchases other transactions utilizing accounts associated with the financial institution. As such, the financial institution may have data associated with products or services that the customer may have recently purchased. In some embodiments, other event data may be utilized singularly or in combination with one or more other event data to predict one or more reasons why the customer may attempt to communicate with the entity in the future.

In some embodiments, modulating communications directs future customer communications such that they may be impactful and useful. As such, the system may modulate the communications channel for each future communication. In this way, the system may develop and/or present a customer with a different interface via an online channel the next time the customer logs on to his/her online or mobile banking. This interface may present the customer with one or more indicators, models, offers, promotions, answers, or the like that are predicted to be why the customer is logging into his/her online or mobile banking application. In this way, the system may modulate communications with the customer to provide more impactful customer relations and customer service.

In some embodiments, the invention may recommend a more appropriate channel for future communications. As such, the customer may do one or more transactions via a specific channel, such as going to a branch location to complete a financial transaction. The next time the customer goes to the branch location, the customer context profile may allow the teller to present the customer with another channel that may be more convenient for that customer to complete the transaction, such a completing the transaction via mobile banking application or the like. As such, the system may determine patterns of customer communication based on the channel the customer typically utilized for a transaction. The system may then identify one or more other channels that are available to the customer that may be more appropriate or expedite the customer's transaction.

In some embodiments, the system, based on the processing of event data may determine one or more talking points for an agent for the next customer communication. As such, the system will process event data, such as external events to determine one or more talking points an agent may discuss with the customer next time the customer is in communication with the entity. These discussion points may be based on the customer's interaction with the entity or these talking points may be based on external life events. The external life events are determined based on transactions the customer has made recently using financial institution accounts. For example, a customer may have purchased a lot of home improvement products lately and may have also applied for a mortgage. As such, the next time the customer communicates with an agent, the agent can discuss the home improvement projects and/or the customer's new home purchase.

In some embodiments, the system may provide one or more offers or discounts to a customer based on prior customer communications may be determined to be available to the customer.

The customer context profile may be generated by the real-time processing of the event data received and is provided to the channels as a communication aid. In some embodiments, the customer context profile may be an interface provided to an agent of the entity. In other embodiments, the customer context profile may be incorporated into the channel. For example, a customer context profile may incorporate customer specific items onto a customer's mobile or online banking application for the customer to view when he/she logs in.

Embodiments of the invention relate to systems, methods, and computer program products for receiving customer event data, wherein customer event data includes information about customer communications with a financial institution and information about transactions the customer made using a financial institution account; analyzing the received customer event data in real-time as the data is received, wherein analyzing the received customer event data includes applying logic to identify trends in customer communications; determining, based on the received customer event data, one or more external life events for the customer, wherein the external life events are determined from a disposition of the customer communications with the financial institution and information associated with the products of the transaction using the financial institution account; predicting, based on the received customer event data and analysis of the received customer event data, one or more future customer communications, wherein the prediction is based on patterns of prior customer communications with the financial institution and prior transactions using the financial institution account; generating a customer context profile, wherein the customer context profile illustrates the trends in customer communications, the external life events of the customer, predicted future customer communications, and dispositions of previous customer communications; and presenting the customer context profile to the appropriate communication channel.

In some embodiments, the invention further comprising providing opportunities for the customer within the financial institution and updating model logic based on received customer event data, wherein opportunities for the customer within the financial institution include offers and promotions based on prior customer communications with the financial institution and information about transactions the customer made using the financial institution account.

In some embodiments, receiving customer communication data further comprises receiving data regarding customer communications made with the financial institution or customer usage of the financial institution account in real-time as the communication or transaction is occurring, wherein customer communication data includes one or more of customer online communications, customer inquiry communications, customer transactions, account status of the customer, and customer status with the financial institution.

In some embodiments, receiving customer communication data further comprises receiving data regarding customer communications made with the financial institution or customer usage of the financial institution account in real-time from one or more communication channels associated with the financial institution or from merchants associated with the transaction, wherein communication channels associated with the financial institution includes online or mobile banking websites or applications, branch locations, or automatic teller machine (ATM).

In some embodiments, presenting the customer context profile to the appropriate communication channel further comprises authenticating the customer associated with the customer context profile prior to presenting the customer context profile to the appropriate communication channel, the authentication occurs via geo-fence identification, personal identification number (PIN), magnetic strip swiping of financial institution card, or password authentication.

In some embodiments, the customer context profile provides an interface which includes information about recent customer events, accounts the customer has with the financial institution, opportunities or offers available to the customer from the financial institution, customer status information, and financial institution solutions for the customer communications. In some embodiments, the customer context profile is adapted to each of the one or more communication channels.

In some embodiments, the customer context profile is adapted to be presented to an agent at a communication channel associated with the financial institution, when the customer communicates with the communication channel, such that the agent has immediate access to information about recent customer events, accounts the customer has with the financial institution, opportunities or offers available to the customer from the financial institution, customer status information, and financial institution solutions for the customer communications.

In some embodiments, the customer context profile is adapted to be integrated into an online or mobile application of the customer, such that the customer has access to information about recent customer events, accounts the customer has with the financial institution, opportunities or offers available to the customer from the financial institution, customer status information, and financial institution solutions for the customer communications adapted for customer viewing.

The features, functions, and advantages that have been discussed may be achieved independently in various embodiments of the present invention or may be combined with yet other embodiments, further details of which can be seen with reference to the following description and drawings.

### BRIEF DESCRIPTION OF THE DRAWINGS

Having thus described embodiments of the invention in general terms, reference will now be made to the accompanying drawings, wherein:

FIG. 1 provides a high level process flow illustrating customer context analysis, in accordance with one embodiment of the present invention;

FIG. 2 provides a customer context analysis communication aid system environment, in accordance with one embodiment of the present invention;

FIG. 3 provides a process map illustrating customer event data input, in accordance with one embodiment of the present invention;

FIG. 4 provides a process map illustrating real time event processing for customer context analysis agent communication aid, in accordance with one embodiment of the present invention;

FIG. 5 provides a process map illustrating a customer context analysis, in accordance with one embodiment of the present invention;

FIG. 6 provides a process map illustrating an agent communication aid process, in accordance with one embodiment of the present invention;

FIG. 7 provides a process map illustrating presenting a customer context profile for customer communications, in accordance with one embodiment of the present invention;

FIG. 8 provides a process map illustrating presenting a customer context profile for customer communications, in accordance with one embodiment of the present invention; and

FIG. 9 provides an example interface of a customer context profile, in accordance with one embodiment of the present invention.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Like numbers refer to elements throughout. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein.

Although some embodiments of the invention herein are generally described as involving a “financial institution,” one of ordinary skill in the art will appreciate that other embodiments of the invention may involve other businesses that take the place of or work in conjunction with the financial institution to perform one or more of the processes or steps described herein as being performed by a financial institution. Still in other embodiments of the invention the financial institution described herein may be replaced with other types of businesses that agent communications aids.

Some portions of this disclosure are written in terms of a financial institution's unique position with respect to customer transactions. As such, a financial institution may be able to utilize its unique position to receive, store, process, retrieve, and present information associated with customer transactions and customer communications.

The embodiments described herein may refer to the term agent. An agent may include one or more individuals associated with an entity that a customer may communicate with. This agent may be a bank teller, a customer service representative, other employee, partner, or the like associated with the entity. Furthermore, a “channel” as used herein may be one or more ways in which a customer may communicate with an entity, such as a financial institution. These channels may include one or more of online or offline channels. Online channels may include applications, clouds, websites, mobile applications, ATMs, or the like. Offline channels may include store locations, drive through locations, or the like.

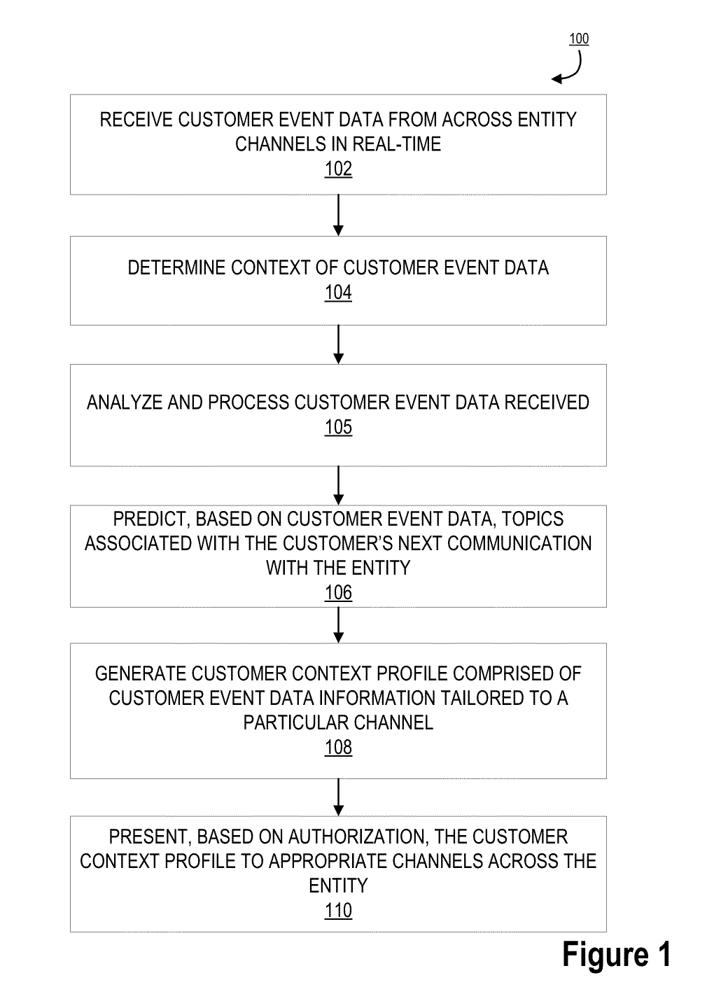

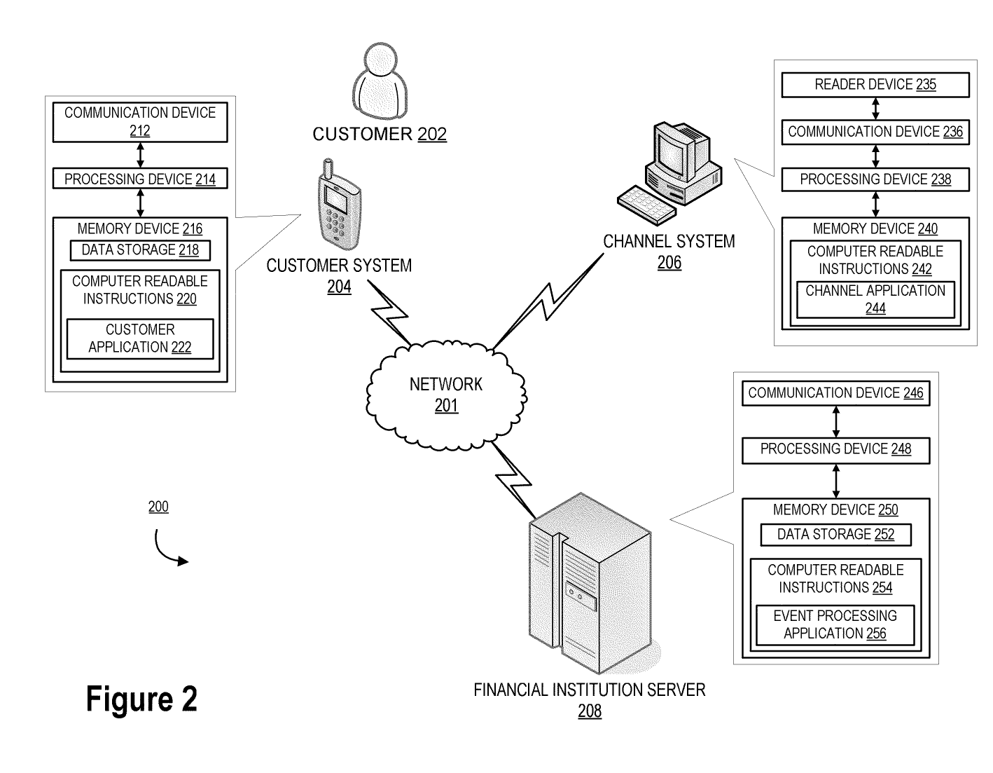

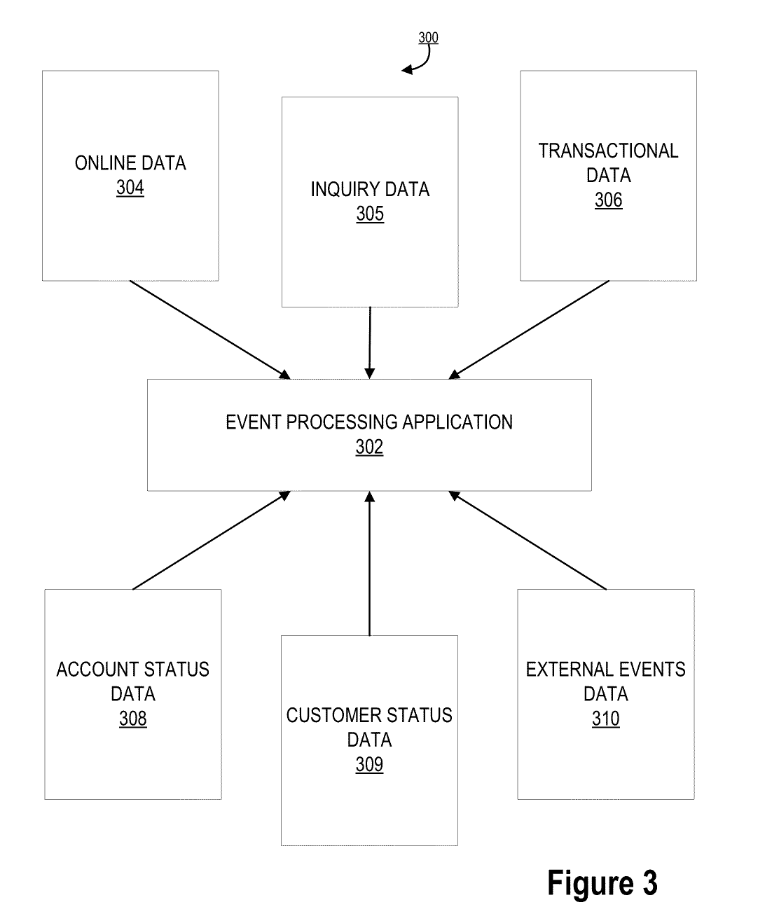

FIG. 1 illustrates a high level process flow for the customer context analysis 100, in accordance with one embodiment of the present invention, which will be discussed in further detail throughout this specification with respect to FIGS. 2 through 9. The first step in the process 100, as illustrated in block 102, is receive customer event data from across the entity. This data is received in real-time or close thereto. The customer event data may be in the form of customer transactions using entity provided account, customer communications with the entity, or the like. A customer, as used herein may include, but is not limited to, a user, individual, person, entity, or other individual that may do business or have an account with a financial institution. Next, as illustrated in block 104, once the customer event data has been received, the system may determine the context of the customer event data. Because customer event data includes several different types of data, as illustrated in further detail below with respect to FIG. 3, the context of the data needs to be determined for further analysis. In this way, the system may determine the type of communication the customer may have made with the entity, the type of transaction, the products of the transaction, or the like.

Next, as illustrated in block 105, the system may analyze and process the customer event data received. In this way, the system incorporates processed customer event data to updated customer context profiles, updating model data, and/or updating offers. In some embodiments, updated customer context profile, updating model data, and/or updating offers allows the system to predict reasons for future communications, modulate communications based on the predicted reason for future communications, recommend more appropriate channels for future communications, determine talking points, or the like to provide improved customer support.

As illustrated in block 106, the process 100 continues by predicting, based on the customer event data processed, topics associated with the customer's next communication with the entity. In this way, based on trends, triggers, algorithms, or the like the system may predict the next customer communication with the entity, the channel of that communication, the topic of that communication, and the like. As such, the entity may be better prepared to serve the customer's needs by having a pre-established prediction of what the customer may be communicating with the entity for. Next, as illustrated in block 108 the process 100 continues to generate or update a customer context profile that is comprised of customer event data information that is tailored to a particular communication channel. As such, an agent may receive an interface with the customer context profile with talking points and other communication topics that the agent may bring up during his/her communications with the customer. In other embodiments, elements from the customer context profile may be presented to the customer via dialog boxes, unique mash ups, widgets, tabs, or the like associated with a mobile or online banking application.

Finally, as illustrated in block 110, customer context profile is presented to the appropriate channels across the entity. This presentation is based on authorization of that channel or agent having access to the specific customer context profile.

FIG. 2 provides a customer context analysis communication aid system environment 200, in accordance with one embodiment of the present invention. As illustrated in FIG. 2, the financial institution server 208 is operatively coupled, via a network 201 to the customer system 204, and to the channel system 206. In this way, the financial institution server 208 can send information to and receive information from the customer system 204 and the channel system 206 to receive customer event data and provide customer context profiles. FIG. 2 illustrates only one example of an embodiment of a customer context analysis communication aid system environment 200, and it will be appreciated that in other embodiments one or more of the systems, devices, or servers may be combined into a single system, device, or server, or be made up of multiple systems, devices, or servers.

The network 201 may be a global area network (GAN), such as the Internet, a wide area network (WAN), a local area network (LAN), or any other type of network or combination of networks. The network 201 may provide for wireline, wireless, or a combination wireline and wireless communication between devices on the network 201.

In some embodiments, the customer 202 is an individual communication with a financial institution. The communication may be via one or more channels associated with the financial institution or entity. As such, the communication may be made at or through a channel system 206 associated with the financial institution. Channels may include one or more branch locations, online websites, mobile applications, online applications, over the phone, at the merchant's place of business, ATM, or other mediums of communication with a financial institution.

In some embodiments, the communication may be made by the customer 202 using a customer system 204, such as a mobile wallet (i.e. smart phone, PDA, and the like) or other types of payment systems that communicate with other systems on the network 201, such as the channel system 206 and/or financial institution servers 208. In some embodiments of the invention, the customer 202 may communicate with the financial institution using his/her customer system 204. In this way, the customer 202 may log on to his/her online or mobile banking application. Furthermore, the customer 202 may enter into transactions using his/her customer system 204, the transaction may be associated with one or more accounts associated with the financial institution. In some embodiments, the customer 202 may be a merchant or a person, employee, agent, independent contractor, and the like that has an account or business with a financial institution.

FIG. 2 also illustrates a customer system 204. The customer system 204 generally comprises a communication device 212, a processing device 214, and a memory device 216. The customer system 204 is a computing system that allows a customer 202 to communicate with the financial institution and enter into transactions both via a network 201. The processing device 214 is operatively coupled to the communication device 212 and the memory device 216. The processing device 214 uses the communication device 212 to communicate with the network 201 and other devices on the network 201, such as, but not limited to the channel system 206 and the financial institution server 208. As such, the communication device 212 generally comprises a modem, server, or other device for communicating with other devices on the network 201.

The customer system 204 comprises computer-readable instructions 220 and data storage 218 stored in the memory device 216, which in one embodiment includes the computer-readable instructions 220 of a customer application 222. In this way, a customer 202 may provide event data, communicate with the financial institution, receive customer context profiles, and/or be able to enter into transactions using the customer application 222. The customer system 204 may be, for example, a desktop personal computer, a mobile system, such as a cellular phone, smart phone, personal data assistant (PDA), laptop, or the like. Although only a single customer system 204 is depicted in FIG. 2, the customer context analysis communication aid system environment 200 may contain numerous customer systems 204.

As further illustrated in FIG. 2, the financial institution server 208 generally comprises a communication device 246, a processing device 248, and a memory device 250. As used herein, the term “processing device” generally includes circuitry used for implementing the communication and/or logic functions of the particular system. For example, a processing device may include a digital signal processor device, a microprocessor device, and various analog-to-digital converters, digital-to-analog converters, and other support circuits and/or combinations of the foregoing. Control and signal processing functions of the system are allocated between these processing devices according to their respective capabilities. The processing device may include functionality to operate one or more software programs based on computer-readable instructions thereof, which may be stored in a memory device.

The processing device 248 is operatively coupled to the communication device 246 and the memory device 250. The processing device 248 uses the communication device 246 to communicate with the network 201 and other devices on the network 201, such as, but not limited to the channel system 206 and the customer system 204. As such, the communication device 246 generally comprises a modem, server, or other device for communicating with other devices on the network 201.

As further illustrated in FIG. 2, the financial institution server 208 comprises computer-readable instructions 254 stored in the memory device 250, which in one embodiment includes the computer-readable instructions 254 of an event processing application 256. In some embodiments, the memory device 250 includes data storage 252 for storing data related to the customer context communication aid including but not limited to data created and/or used by the event processing application 256.

In the embodiment illustrated in FIG. 2 and described throughout much of this specification, the event processing application 256 received event data, processes event data in real-time, and generates and/or updates customer context profiles, model data, and/or offers. As such, updated customer context profile, updating model data, and/or updating offers allows the system to predict reasons for future communications, modulate communications based on the predicted reason for future communications, recommend more appropriate channels for future communications, determine talking points, or the like to provide improved customer support.

The event processing application 256 first receives event data for processing via the processing device 248. The event processing application 256 may process the received event data to subsequently process for predicting communications based on event data and generates and/or updates customer context profiles, model data, and/or offers from that event data. The event process application 256 receives various types of customer event data to process and generate the predictions and/or updates. As such, event data is received from one or more systems on the network 201, such as, but not limited to the customer system 204 and the channel system 206. In some embodiment, customer event data includes online data and/or inquiry data. Online data includes information about a customer's online or mobile activity. Specifically, online date may include whenever a customer 202 accesses his/her online or mobile banking application or portal. Each time a customer 202 accesses his/her online banking portal the system may identify the items viewed, requested, selected, or the like on the customer's portal. As such, this data may be provided to the event processing application 256 and stored as event data associated with the customer 202 in the memory device 250. Customer event data may also include inquiry data. Inquiry data includes any inquiry a customer 202 makes to the financial institution, irrespective of the channel the customer 202 is making the inquiry. As such, if a customer 202 inquires about opening a savings account, a mortgage, checking account, credit card, or other inquire with respect to products or services associated with the financial institution. The event processing application 256 may receive the inquiry data and process the data to be used to update the customer's context profile and aid in predicting the next communication the customer 202 may make with the financial institution.

In some embodiments customer event data received by the event processing application 256 includes transaction data. Transactional data may be received by the financial institution if the customer utilizes an account associated with the financial institution for the transaction. As such, when a customer 202 utilizes a financial institution account for a transaction the event processing application 256 may receive information about the transaction and process that information into event data to be used to update the customer's context profile and aid in predicting the next communication the customer 202 may make with the financial institution. In some embodiments customer event data received by the event processing application 256 includes account status data. Account status data includes one or more status updates associated with accounts a customer 202 may have with the financial institution. As such, the status of a customer's account may be received by the event processing application 256 and processed into event data to be used to update the customer's context profile and aid in predicting the next communication the customer 202 may make with the financial institution.

In some embodiments customer event data received by the event processing application 256 includes customer status data. Customer status data includes any information about the number of accounts, length of time, or the like the customer 202 has been with the financial institution. As such, this status information may be received and processed into event data to be used to update the customer's context profile and aid in predicting the next communication the customer 202 may make with the financial institution. In some embodiments customer event data received by the event processing application 256 includes external events data. External event data may be extracted from one or more other types of event data received. External event data includes data that provides an indication as to a life event associated with the customer 202. This way, the external events of the customer 202 may be used to update the customer's context profile and aid in predicting the next communication the customer 202 may make with the financial institution.

In some embodiments, the event processing application 256 processes the customer event data received. The processing is done in real-time as the customer event data is received by the event processing application 256. The processing via the processing device 248 may take all of the various customer event data and combine the event data. The processing includes logic, rules, algorithms, and intelligence to process the event data. The processing includes customer context analysis of the customer event data. The processing determines or predicts what the customer 202 will be wishing to discuss during his/her next communication. As such, a probability tool is incorporated based on modeling and prior experiences into the event processing application 256. Furthermore, the event processing application 256 also stores dispositions associated with recent customer 202 communications in the memory device 250. As such, when the customer 202 next communicates with the financial institution, then the agent the customer 202 is in contact with may be up to date as to the customer's recent communications with the financial institution. The event processing application 256 will look for trends based on logic and/or rules in customer 202 communications such that it may provide insight into what future communications the customer 202 may make. Furthermore, the event processing application 256 may provide one or more offers or alternative communication channels for the customer 202 based on his/her prior communication and prior communication channels.

The event processing application 256 also generates and/or updates customer context profiles, model data, and/or offers. As such, updated customer context profile, updating model data, and/or updating offers allows the system to predict reasons for future communications, modulate communications based on the predicted reason for future communications, recommend more appropriate channels for future communications, determine talking points, or the like to provide improved customer support.

In some embodiments, the event processing application 256 predicts one or more reasons why the customer may attempt to communicate with the entity in the future. This allows the event processing application 256 to prepare the communication channel for customer 202 interaction and allows for improved customer service. Predicting one or more reasons why the customer will be communicating with the entity in the future is determined by event data collected from above.

In some embodiments, the event processing application 256 modulates communications directs future customer communications such that they may be impactful and useful. As such, the event processing application 256 may modulate the communications channel for each future communication. As such, the event processing application 256 may develop and/or present a customer 202 with a different interface via an online channel the next time the customer 202 logs on to his/her online or mobile banking. This interface may present the customer 202 with one or more indicators, models, offers, promotions, answers, or the like that are predicted to be why the customer 202 is logging into his/her online or mobile banking application. In this way, the system may modulate communications with the customer 202 to provide more impactful customer relations and customer service.

In some embodiments, the event processing application 256 may also recommend a more appropriate channel for future communications based on the modulating of communications. As such, the customer 202 may do one or more transactions via a specific channel, such as going to a branch location to complete a financial transaction. The next time the customer 202 goes to the branch location, the customer context profile may allow the teller to present the customer 202 with another channel that may be more convenient for that customer 202 to complete the transaction. As such, the event processing application 256 may determine patterns of customer 202 communication based on the channel the customer 202 typically utilized for a transaction. The event processing application 256 may then identify one or more other channels that are available to the customer 202 that may be more appropriate or expedite the customer's transaction.

In some embodiments, the event processing application 256 may also determine one or more talking points for an agent for the next customer 202 communication. As such, the event processing application 256 will process event data, such as external events to determine one or more talking points an agent may discuss with the customer 202 next time the customer 202 is in communication with the entity. These discussion points may be based on the customer's interaction with the entity or these talking points may be based on external life events. The external life events are determined based on transactions the customer 202 has made recently using financial institution accounts. For example, a customer 202 may have purchased a lot of home improvement products lately and may have also applied for a mortgage. As such, the next time the customer 202 communicates with an agent, the agent can discuss the home improvement projects and/or the customer's new home purchase.

In some embodiments, the event processing application 256 may provide one or more offers or discounts to a customer 202 based on prior customer communications may be determined to be available to the customer.

Finally, the customer context profile may be generated by the event processing application 256 and is provided to the channels as a communication aid. In some embodiments, the customer context profile may be an interface provided to an agent of the entity. In other embodiments, the customer context profile may be incorporated into the channel. For example, a customer context profile may incorporate customer specific items onto a customer's mobile or online banking application for the customer to view when he/she logs in.

As illustrated in FIG. 2, the channel system 206 is associated with the channel that the customer 202 is communication with. As such, the customer 202 may be able to communicate with the entity via several different means or channels. These may include online or offline communication channels. Online communications may include one or more of communications via a website, application, chatting, email, or the like that may occur over a network 201. Offline communication channels may include the customer going to a store location, an ATM, or the like. The channel system 206 generally comprises a reading device 235, a communication device 236, a processing device 238, and a memory device 240. The reading device 235 is operatively coupled to the processing device 238, communication device 236, and the memory device 240. The channel system 206 may include a reader device 235 to receive authentication of customer 202 access to his/her accounts at the financial institution. Such a reader device 235 may include a magnetic strip reader, a barcode scanner, a radio frequency (RF) reader, a character recognition device, a magnetic ink reader, a processor for interpreting codes presented over an electrical or optical medium, a biometric reader, a wireless receiving device, and/or the like. In some embodiments, the reading device 235 receives information that may be used to identify the consumer's payment account and/or transaction data at the channel system 206 and communicates the information via the communication device 236 over a network 201, to other systems such as, but not limited to the financial institution server 208 and/or the customer system 204. As such, the communication device 236 generally comprises a modem, server, or other device for communicating with other devices on the network 201.

As further illustrated in FIG. 2, the channel system 206 comprises computer-readable instructions 242 stored in the memory device 240, which in one embodiment includes the computer-readable instructions 242 of a channel application 244.

In the embodiment illustrated in FIG. 2, the channel application 244 allows the channel system 206 to be linked to the financial institution server 208 and customer system 204 to communicate, via a network 201, the information related to the customer context profile, such as customer 202 data, previous customer 202 communications, predicted customer 202 communications, offers, opportunities, talking points, and the like. Furthermore, the channel application 244 may identify a customer 202 when he/she enters a location associated with a financial institution. In some embodiments the channel application 244 may identify a customer 202 by customer authorization at the reader device 235. In some embodiments, the channel application 244 may identify the customer 202 based on agent or customer 202 input. In yet other embodiments, the channel application 244 may identify the customer 20e as being a pre-determined distance away from the branch location. This may be done via geo-fencing or geo-locating of the customer 202 via the customer system 204 being within the geo-fencing range

In this way, the channel application 244 may identify that a communication has been initiated between the customer 202 and the financial institution channel. Furthermore, the channel application 244 may store information associated with the date, time, channel, disposition, and the like associated with the communication in the memory device 240.

The channel system 206 may also, upon identifying the customer 202 is initiating a communication at the channel associated with that channel system 206 may receive and present, via the communication device 236 the customer context profile for the customer 202 from the financial institution server 208. Thus, the customer context profile may provide the channel with a communication aid based on customer context analysis, such that the communication channel can or effectively assist a customer 202.

It is understood that the servers, systems, and devices described herein illustrate one embodiment of the invention. It is further understood that one or more of the servers, systems, and devices can be combined in other embodiments and still function in the same or similar way as the embodiments described herein.

FIG. 3 illustrates a process map for customer event data input 300, in accordance with one embodiment of the present invention. Customer event data may be received by an event processing application 302. The event processing application 302 may process the received event data and subsequently predict communications based on event data and generates and/or updates customer context profiles, model data, and/or offers from that event data. The event process application 302 receives various types of customer event data to process and generate the predictions and/or updates. As such, the customer event data may come from one or more sources, such as, but not limited to the customer 202, the financial institution, outside entities, other financial institutions, or the like.

In one embodiment, as illustrated in block 304, customer event data includes online data and/or inquiry data. Online data includes information about a customer's online or mobile activity. Specifically, online date may include whenever a customer 202 accesses his/her online or mobile banking application or portal. Upon accessing the customer's online banking application, the system may determine what the customer 202 may have viewed while on his/her online banking application. For example, a customer 202 may log into an online banking website by entering a username and a password. Subsequently the customer 202 may manage his/her accounts on the online banking website. As such, the customer 202 may transfer funds, view balances, apply for credit, or the like. Each time a customer 202 accesses his/her online banking portal the system may identify the items viewed, requested, selected, or the like on the customer's portal. As such, this data may be provided to the event processing application 302 and stored as event data associated with the customer 202. This way, the online activity of the customer 202 may be used to update the customer's context profile and aid in predicting the next communication the customer 202 may make with the financial institution.

As illustrated in block 305, customer event data may also include inquiry data. Inquiry data includes any inquiry a customer 202 makes to the financial institution, irrespective of the channel the customer 202 is making the inquiry. As such, if a customer 202 inquires about opening a savings account, a mortgage, checking account, credit card, or other inquire with respect to products or services associated with the financial institution. As such, if the customer 202 goes online and requests a product or service, goes to a branch location and inquires about a product or service, goes to an ATM to inquire about a product or service, or the like, the system may receive the inquiry data and process the data to be used to update the customer's context profile and aid in predicting the next communication the customer 202 may make with the financial institution.

In one embodiment, as illustrated in block 306, customer event data includes transaction data. Transactional data may be received by the financial institution if the customer utilizes an account associated with the financial institution for the transaction. For example, a customer 202 may purchase Product 1 at Merchant A. The transaction may be completed by the customer 202 using his/her credit card that was provided to the customer 202 from the financial institution. As such, the financial institution may receive transaction data for processing that includes a transaction at Merchant A for Product 1. As such, when a customer 202 utilizes a financial institution account for a transaction the system may receive information about the transaction and process that information into event data to be used to update the customer's context profile and aid in predicting the next communication the customer 202 may make with the financial institution.

In one embodiment, as illustrated in block 308, customer event data includes account status data. Account status data includes one or more status updates associated with accounts a customer 202 may have with the financial institution. These accounts may include one or more of a checking account, savings account, investment account, credit card, mortgage, loan, line of credit, or the like. The status of these accounts may include the amount, the balances, uses of the account, and the like. As such, the status of a customer's account may be received by the system and processed into event data to be used to update the customer's context profile and aid in predicting the next communication the customer 202 may make with the financial institution.

In one embodiment, as illustrated in block 309, customer event data includes customer status data. Customer status data includes any information about the number of accounts, length of time, or the like the customer 202 has been with the financial institution. This status information may be useful for predicting one or more future communications the customer 202 may have. This information may also be utilized to provide offers or other programs to the customer 202 for his/her continued support of the entity. As such, this status information may be received and processed into event data to be used to update the customer's context profile and aid in predicting the next communication the customer 202 may make with the financial institution.

In one embodiment, as illustrated in block 310, customer event data includes external events data. External event data may be extracted from one or more other types of event data received. External event data includes data that provides an indication as to a life event associated with the customer 202. This external event data is predicted based on the other data that the financial institution may be able to determine based on accounts, transactions, and the like. For example, a customer 202 may purchase Product 1 at Merchant A. The transaction may be completed by the customer 202 using his/her credit card that was provided to the customer 202 from the financial institution. The financial institution may determine that Product 1 is a baby's crib. This may be determined based on the credit card statement, receipt, or the like. As such, the system may identify that the customer 202 may have recently had a child and/or knew a close relative that had a child. Thus, this information may be included in the customer context profile as a talking point or the like for the next communication that the customer 202 may have with the financial institution. This way, the external events of the customer 202 may be used to update the customer's context profile and aid in predicting the next communication the customer 202 may make with the financial institution.

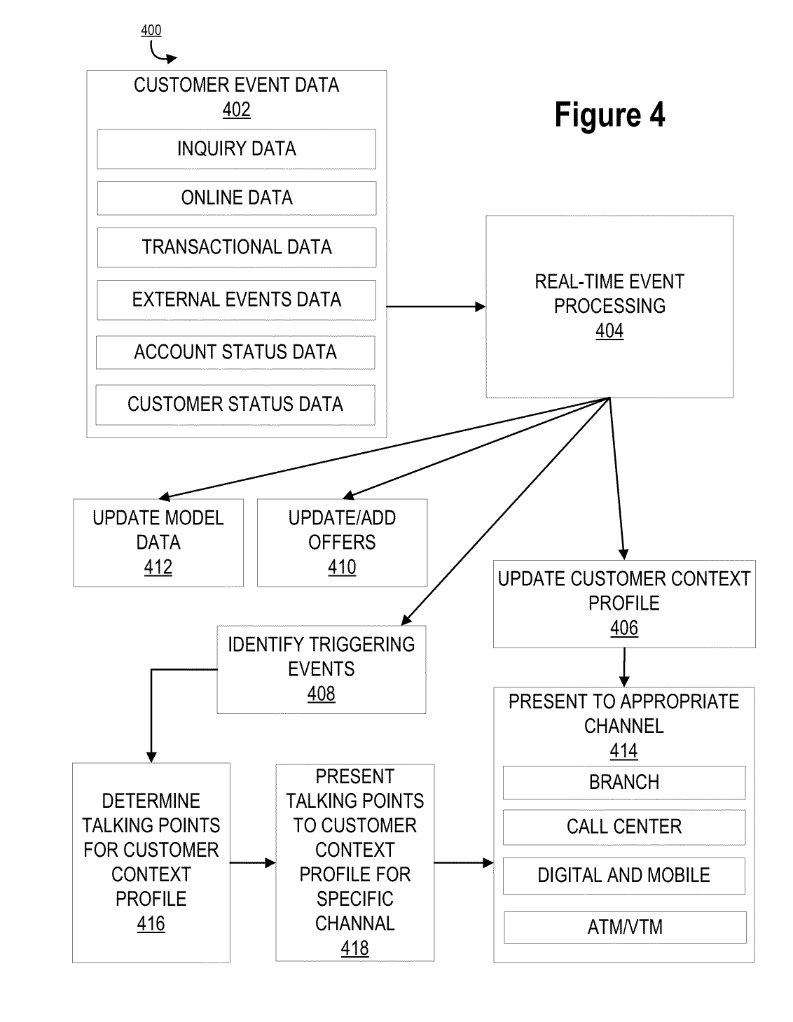

FIG. 4 provides a process map illustrating real time event processing for customer context analysis agent communication aid 400, in accordance with one embodiment of the present invention. The first step in the process 400, is to receive customer event data 402. As illustrated above in FIG. 3, the customer event data may include online data, inquiry data, transactional data, external event data, account status data, and/or customer status data. The customer event data received in block 402 is then processed via real-time event processing as illustrated in block 404. In this way, the system may take all of the various customer event data and combine the event data. The real-time processing 404 receives the event data as or shortly after the event occurs. The real-time processing 404 includes logic, rules, algorithms, and intelligence to process the event data. The processing includes customer context analysis of the customer 202 event data. The processing determines or predicts what the customer 202 will be wishing to discuss during his/her next communication. As such, a probability tool is incorporated based on modeling and prior experiences. Furthermore, the real-time processing 404 also stores dispositions associated with recent customer 202 communications. As such, when the customer 202 next communicates with the financial institution, then the agent the customer 202 is in contact with may be up to date as to the customer's recent communications with the financial institution. The processing will look for trends based on logic and/or rules in customer 202 communications such that it may provide insight into what future communications the customer 202 may make. Furthermore, the processing may provide one or more offers or alternative communication channels for the customer 202 based on his/her prior communication and prior communication channels.

Next, the event data, after being processed in block 404 may be used to updated model data 412, updated or add offers 410, and/or updated customer context profiles 406. As illustrated in block 412, the process 400 may use event data that has been processed in block 404 to updated model data. In some embodiments, updated customer context profile, updating model data, and/or updating offers allows the system to predict reasons for future communications, modulate communications based on the predicted reason for future communications, recommend more appropriate channels for future communications, determine talking points, or the like to provide improved customer support.

Predicting one or more reasons why the customer may attempt to communicate with the entity in the future allows the system to prepare the agent for customer interaction and allows for improved customer service. Prediction one or more reasons why the customer will be communicating with the entity in the future is determined by event data collected from above. This includes event data about previous communications, including the date, time, channel, reason, and outcome for each of the previous communications. The data comprised about previous communications allows the system to predict a routine associated with customer communications and the like. Furthermore, event data may also include one or more transaction a customer may have made. These transactions may include one or more purchases other transactions utilizing accounts associated with the financial institution. As such, the financial institution may have data associated with products or services that the customer may have recently purchased. In some embodiments, other event data may be utilized singularly or in combination with one or more other event data to predict one or more reasons why the customer may attempt to communicate with the entity in the future.

In some embodiments, modulating communications based on the predicted reason for future communications directs future customer communications such that they may be impactful and useful. As such, the system may modulate the communications channel based on the processing. In this way, the system may develop and/or present a customer with a different interface via an online channel the next time the customer logs on to his/her online or mobile banking. This interface may present the customer with one or more indicators, models, offers, promotions, answers, or the like that are predicted to be why the customer is logging into his/her online or mobile banking application. In this way, the system may modulate communications with the customer to provide more impactful customer relations and customer service.

In some embodiments, the invention may recommend a more appropriate channel for future communications. As such, the customer may do one or more transactions via a specific channel, such as going to a branch location to complete a financial transaction. The next time the customer goes to the branch location, the customer context profile may allow the teller to present the customer with another channel that may be more convenient for that customer to complete the transaction, such a completing the transaction via mobile banking application or the like. As such, the system may determine patterns of customer communication based on the channel the customer typically utilized for a transaction. The system may then identify one or more other channels that are available to the customer that may be more appropriate or expedite the customer's transaction.

Updating model data 412 includes updating rules and the like for determining and providing the highest probability and description of the purpose of the customer 202 communication. In this way, the model data continuously updated to aid in predicting the reason for customer 202 communications in the future. Updating model data 412 may include one or more automatic or manual updating of rules, logic, intelligence, predictors, or the like associated with providing a customer context profile with a holistic view of the customer 202 and the customer's communications.

As illustrated in block 410, the process 400 may use event data that has been processed in block 404 to updated and/or add offers. Offers may be one or more suggestions, products, promotions, rewards, or opportunities to be presented to the customer 202 at the next customer communication. As such offers include discounts, percent off coupons, product discounts, or the like. Offers may be presented based on a prior customer 202 communication, such as a communication with a call center, agent, or the like. Furthermore, offers may also be based on one or more transactions the customer 202 has completed. The offers may be added or updated onto the customer context profile, in order to be presented to the customer 202 at the next communication.

As illustrated in block 412, the process 400 may use event data that has been processed in block 404 to updated model data. Updating model data may include utilizing the event data to update one or more models used for predicting reasons for future communications, modulate communications based on the predicted reason for future communications, recommending more appropriate channels for future communications, determining talking points, or the like to provide improved customer support. Model data allows for updating of the logic and the like for predictability. After each customer event is received and processed in real-time the model data may be continued to be updated.

As illustrated in block 406, the process 400 may be used to update customer context profile. The customer context profile, as described throughout this application, presents the information determined by the logic of the real-time processing. The customer context profile can be presented to agents or other communication channels that have communication with the customer 202. The customer context profile provides the information from the customer event processing for agents and other communication channels. This information is distributed such that it illustrates the prediction of reasons for customer 202 further communications. Furthermore, the information may aid the agent in communication with the customer 202. In this way, the information may contain appropriate channels for further communications, present one or more talking points based on the event data, or the like to improve customer 202 service and customer 202 interactions.

Subsequently, the updated customer context profile, as illustrated in block 406, may be presented to one or more of the appropriate communication channels, as illustrated in block 414. These communication channels include one or more of branch, call centers, digital and mobile channels, and ATMs.

As further illustrated in FIG. 4, the real-time event processing 404 may also identify triggering events, as illustrated in block 408. Triggering events may trigger the system to flag the events to present talking points for the customer context profile. Triggering events may be a single event and/or multiple events that are compiled together to determine a life event of a customer 202 that may trigger a talking point. These life events may include one or more important events that a customer 202 may have in his/her life, such as moving, a wedding, anniversary, graduation, retirements, children, and/or the like.

As illustrated in block 416, the triggering event identified in block 408 is utilized to determine talking points for the customer context profile for the life event identified from that triggering event. The talking points may include one or more data about the customer's life event that was identified by the triggering event identified in block 408. The talking point may then be presented to the customer context profile for one or more specific channels, as illustrated in block 418. In this way, the talking point may be presented to an appropriate channel in block 414. The system may identify one or more channels to present the talking points to, such that not all channels may be presented with the talking points via the customer context profile. This way, the system may be able to tailor the customer context profile with different data based on the communication channel that the customer context profile is presented to.

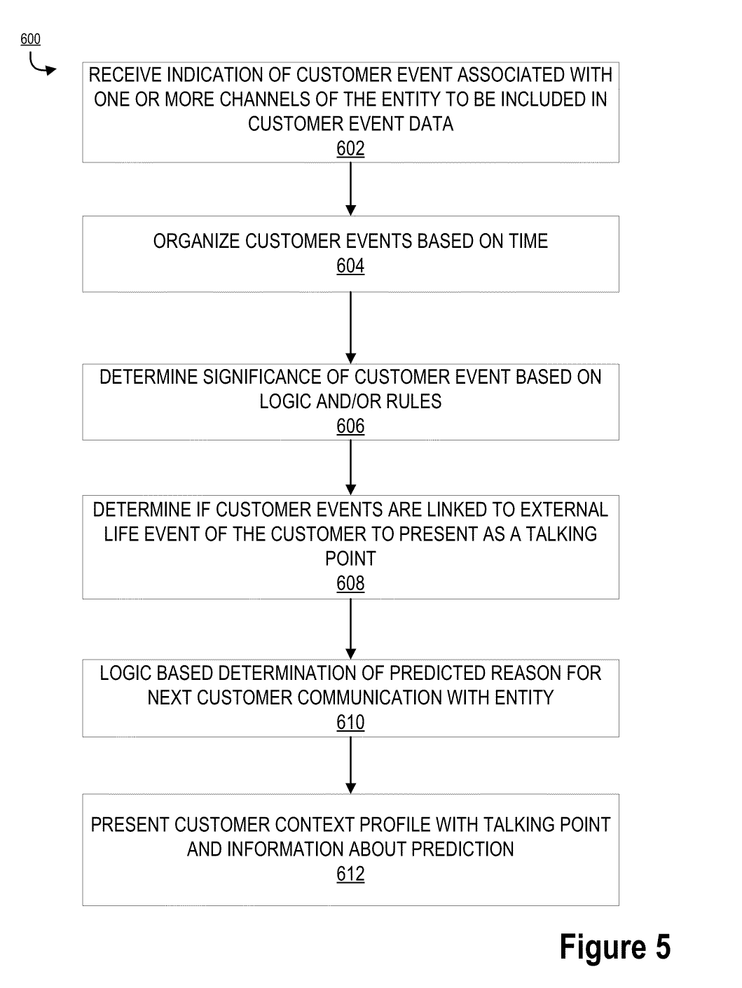

FIG. 5 illustrates a process map for a customer context analysis 600, in accordance with one embodiment of the present invention. FIG. 5 illustrates determining talking points based on one or more triggering events. As illustrated in block 602, the process 600 starts by receiving an indication that customer event associated with one or more communication channels has occurred. This customer event data is to be included in the customer event data for processing. Next, as illustrated in block 604, the customer event data is organized based on time within the processing of the event data. As such, the system may determine that the more current in time customer event data may be more relevant to the customer's future communications and/or the topic associated with that subject.

Next, as illustrated in block 606, the system may determine the significance of the customer event within the customer event data. In some embodiments, the significance of the event may determine the weighting of the event with respect to predicting the future customer communications. The significance of the event may be determined by pre-established logic, algorithms, rules, agent inputted data, or the like. The determined significance of the most recent customer 202 communications or events may determine the predicted reason a customer 202 may contact the financial institution again. For example, if it is determined that a customer 202 contacted a call center recently regarding the transfer that did not complete, the system may determine that until the transfer is complete, that the customer 202 will be communicating with the communication channel regarding the transfer. Furthermore, the system may identify and attempt to provide a solution via the updating/add offers function and present that and the predicted reason for communication to the channel or agent in which the customer 202 contacts.

Next, as illustrated in block 608, the process 600 continues to determine if one or more customer communication or event is linked to an external life event of the customer 202 that triggers a talking point. In this way, the system may determine if one or more triggering event has occurred.

Next, as illustrated in block 610, the process 600 continues to determine a predicted reason for the next customer communication with the financial institution. Typically, this is determined based on logic, rules, or the like. Once predicted, the system may create a customer context profile based on the prediction with the most recent data associated with customer 202 communications.

Finally, as illustrated in block 612, the process 600 ends by presenting the customer context profile with talking points (if triggers are identified in block 608) and information about predicted next customer 202 communications.

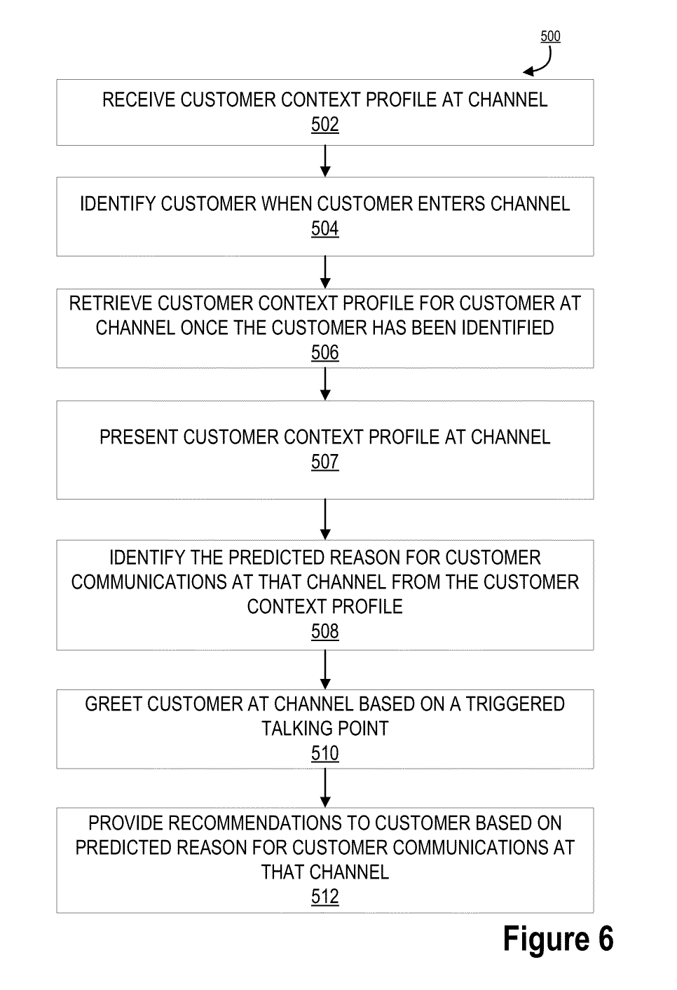

FIG. 6 illustrates a process map for an agent communication aid process 500, in accordance with one embodiment of the present invention. The process 500 starts by receiving a completed and updated customer context profile at a communication channel, as illustrated in block 502. This customer context profile may have been processed and updated utilizing customer event data. The communication channel may be one or more locations that a customer may communicate with the financial institution, these may include, but are not limited to, online, mobile, brick-and-mortar, ATM, or the like location.

Once the customer context profile for that particular customer is received at the channel, the received customer context profiles are stored at the channel. Subsequently, the customer 202 may enter the channel to communicate with the financial institution. As illustrated in block 504 the customer 202 may be identified when he/she enters the communication channel. In some embodiments the communication channel may be via the customer's online or mobile banking application. As such, the customer 202 may log into his/her online or mobile banking. The log in of the customer 202 triggers the customer context profile for that customer 202. As such, the system identifies the customer 202 based on the customer's authentication and logging into his/her online or mobile banking. In some embodiments, the communication channel the customer 202 may communicate with the financial institution may include an ATM or the like.

In this way, the customer 202 may have to provide a credit or debit card to the ATM and provide a personal identification number (PIN) associated therewith. Providing the credit or debit card and the PIN associated therewith triggers presentment of the customer context profile for that customer 202. In some embodiments, the customer 202 may communicate with the financial institution by physically going to the financial institution branch. In this way, when the customer 202 enters the branch, the system may identify the customer 202 either by an agent speaking with the customer 202, customer authorization via credit or debit card, PIN authorization, or the like.

Once the system has identified the customer when he/she enters the communication channel in block 504, the process 500 continues to retrieve the customer context profile for the customer at the channel, as illustrated in block 506. The customer context profile may be stored at the financial institution server 208 or the channel system 206. In this way, the channel may have quick access to the one or more customer context profiles necessary for each customer 202 as that customer 202 initiates communication with the financial institution. Next, as illustrated in block 507, the retrieved customer context profile is then presented to the communication channel. In some embodiments, the customer context profile is presented to an agent of the entity at the communication channel. In some embodiments, the customer context profile or information therefrom is incorporated into an interface viewed by the customer 202, such as the online or mobile application, online banking website, or the like.

Next, as illustrated in block 508, the agent and or channel may review the customer context profile to identify the predicted reasons for the customer 202 communication at that channel. In this way, the system may present recent customer 202 communications and outcomes to the agent for review immediately prior to the customer 202 communication with that agent or channel. Upon reviewing the customer context profiled to determine the reason for the customer 202 communication the agent or channel may greet the customer 202 at the communication channel based a talking point, as illustrated in block 510. The talking point may have been triggered based on event data of the customer 202. The talking point may be presented via the customer context profile such that the agent may immediately view and discuss the event with the customer 202. The talking point may be based on the customer 202 communications with the financial institution, transactions of the customer 202, and/or external life events derived from the customer event data.

Finally, in some embodiments, the customer context profile may provide recommendations to the agent to present to the customer 202. As such, as illustrated in block 512, the channel or agent may provide recommendations to the customer 202 based on the predicted reason for the customer 202 communications at that channel.

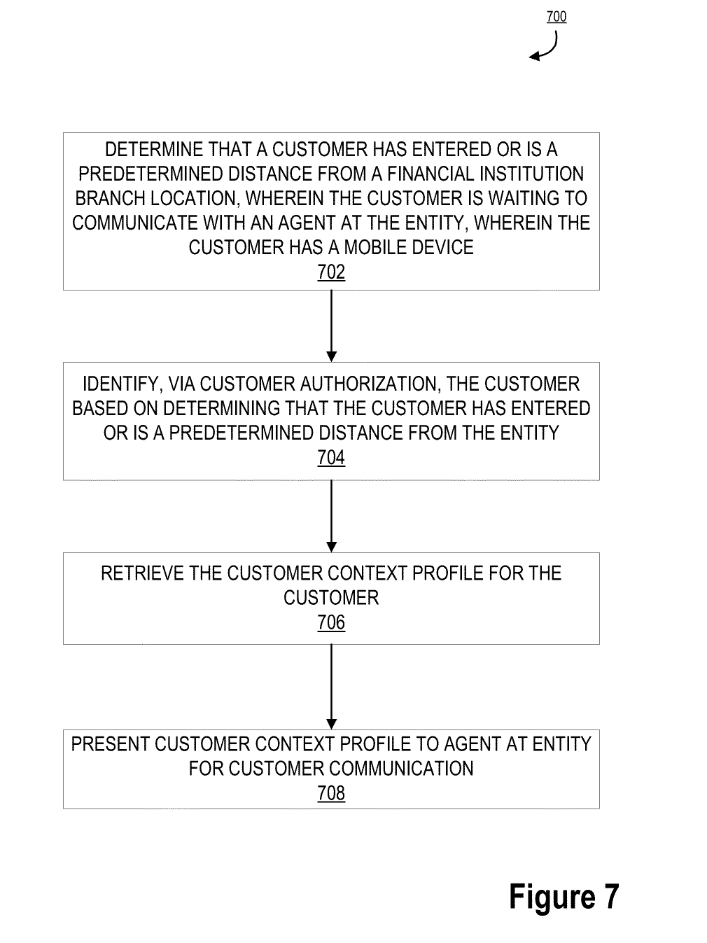

FIG. 7 illustrates a process map for presenting a customer context profile for customer communications 700, in accordance with one embodiment of the present invention. The process 700 map illustrated in FIG. 7 provides a view of utilizing the customer context profile when a customer 202 enters a branch of the financial institution. The process 700 is initiated at block 702 when it is determined that a customer 202 has entered or is a predetermined distance from the financial institution branch. In some embodiments, the customer 202 may have entered the financial institution. In other embodiments, the customer 202 may have been identified as being a pre-determined distance away from the branch location. This determination may be done via geo-fencing or geo-locating of the customer 202 via the customer system 204 or mobile device being within the geo-fencing range.

Next, as illustrated in block 704, the process 700 continues by identifying the customer 202 at the financial institution branch location. The identification is based on determining that the customer 202 has entered the branch. Furthermore, as illustrated in block 704, the identification of the customer 202 may be an authorized identification of the customer 202. The authorized identification of the customer 202 may include the customer 202 presenting identification such as a name, credit or debit card swipe, PIN, or the like. This way, the agent at the branch may be able to access one or more accounts associated with the customer 202.

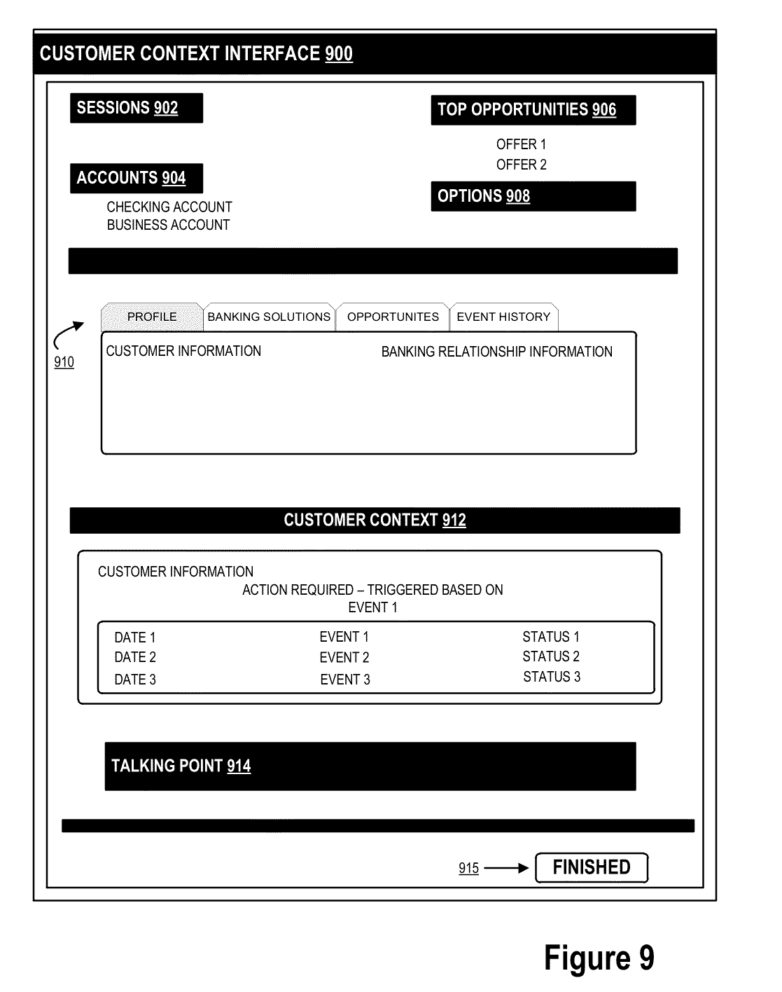

Next, as illustrated in block 706, once the customer 202 has been positively identified, the system will retrieve the customer context profile for that customer 202. Then, the customer context profile will be presented to the agent in communication with the customer 202 via an interface, as illustrated in block 708. This way, the agent may be prepared to communicate effectively with the customer 202. An example of a customer context profile interface is illustrated below with respect to FIG. 9.

FIG. 9 illustrates an example of a customer context profile interface 900, in accordance with one embodiment of the present invention. As illustrated on the customer context profile interface 900 that is presented to an agent prior to or at initiation of the customer 202 communication. At section 902 the sessions associated with that customer 202 are presented. There may be one or more sessions the customer 202 may have had within the last day/week/month. This section 902 also allows the agent to search the sessions and communications that a customer 202 has had previously. Next, as illustrated in section 904, the accounts the customer 202 has with the financial institution are displayed. These accounts may include one or more checking accounts, savings accounts, credit cards, loans, mortgages, lines of credit, or the like. Section 906 provides the agent with the top opportunities the customer 202 may have. These opportunities are based on customer event data received. As such, top opportunities may offers or promotions based on past customer 202 transactions, communications, life events, or the like. In the example customer context profile interface 900 illustrated in FIG. 9, there are two opportunities that the agent may be able to present to the customer 202 if the agent wishes to do so, these include offer 1 and Offer 2. Finally, section 908 illustrates an options category, allowing for various options with respect to eh customer context interface 900. These options include agent verification, commitment, opening a new account, refreshing a profile, providing maintenance, setting future appointments for the customer 202, sales tools, general tools, inquiry tools, opportunities management, and recent customer options.

As further illustrated in FIG. 9, section 910 of the customer context profile interface 900 includes the interface's main screen functions and tabs. These include viewing the customer profile, banking solutions for the customer, opportunities for the customer, and event history for the customer. The customer 202 profile section may include customer 202 information, such as the title, address, and other contact information associated with the customer 202. This profile also includes bank relationship information such as how long the customer 202 has been a bank customer, the party identification, relationship manager, total balances, accounts, and/or other information that the customer 202 may have in affiliations with the financial institution. Banking solutions include any solutions that the system has developed based on past customer communications or transactions. For example, a solution may stem from a recent telephone call the customer 202 made to a call center. The agent may follow up with solutions for that prior call to the call center. Opportunities will link back to the offers or promotions that the financial institution may have available for the customer 202. Finally, the event history tab provides a quick view of the most recent events of the customer 202. These events may include any events that are added as customer event data. The event history tab may also disclose the time, date, disposition, and the like associated with the one or more recent events for the customer 202.

Next, as illustrated in section 912, the customer context profile interface 900 includes a pop up indicator with customer context. The pop up customer context comprises a quick view of the important customer 202 information on the customer context profile interface 900. This customer context section 912 includes customer information, customer events, and whether action is required based on a triggering event. In the example illustrated in FIG. 9, the there is an action that is required by the agent upon communication with the customer 202. This action is based on an event, specifically Event 1. There are three events listed as pertinent customer information, Event 1, Event 2, and Event 3. Each event includes a date Date 1, Date 2, and Date 3. Furthermore, each event has a status, such as a disposition of the event, these include Status 1, Status 2, and Status 3.

As illustrated in section 914, there may be a talking point that the agent may start the communication with the customer 202. This talking point may be presented directly to the agent via the customer context profile interface 900 such that the agent may initiate the customer 202 communication with the talking point. Finally, when the communication is complete, the agent may select the finish button 915 to exit out of the customer's context profile interface 900.

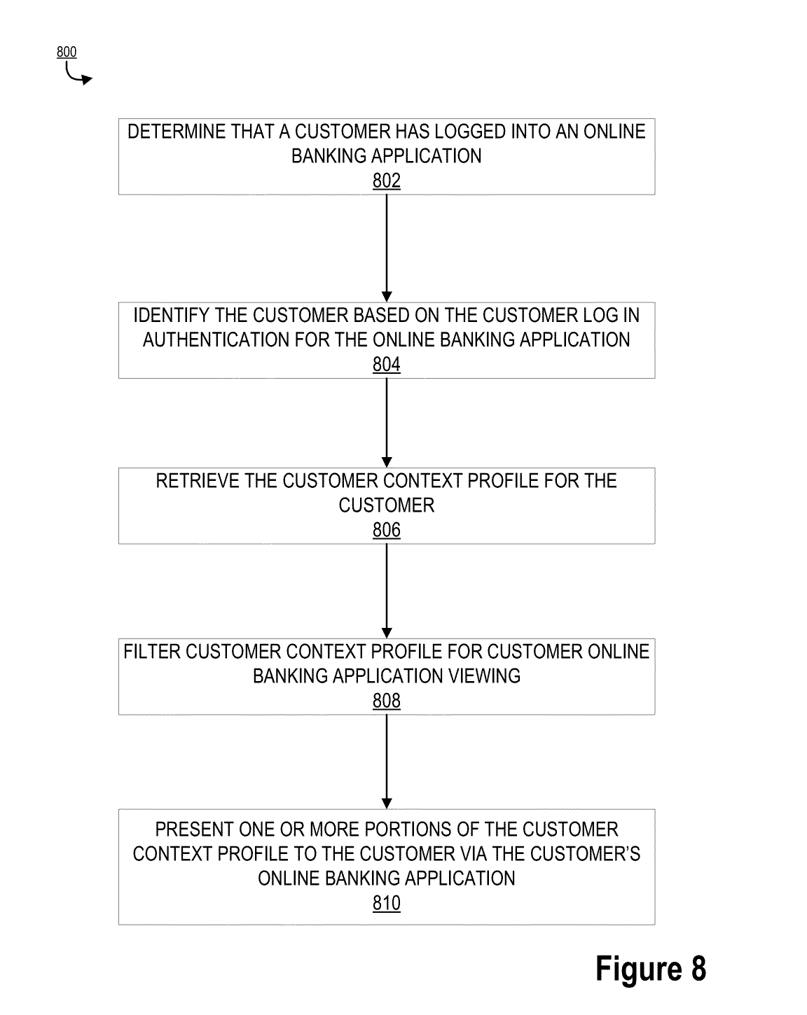

FIG. 8 illustrates a process map for presenting a customer context profile for customer communications 800, in accordance with one embodiment of the present invention. The process 800 illustrated in FIG. 8 discloses presenting a customer context profile for customer communications when the customer communications is via an online or mobile application channel. As illustrated in block 802, the process 800 is initiated by determining that a customer 202 has logged into an online or mobile banking application. Once the customer 202 has logged into and authorized himself/herself by including a log in password and user name, the system may identify the customer 202 based on the customer log in and authentication, as illustrated in block 804.

Next, as illustrated in block 806, the system will retrieve the customer context profile for the customer 202. This retrieval is automatic based on the identification of the customer 202 based on his/her logging into his/her online banking. The customer context profile is retrieved before the customer 202 is redirected to his/her online banking application interface which includes the customer's account information. Then, as illustrated in block 808, the process 800 continues by filtering the customer context profile for customer 202 online banking application viewing. As such, the customer context profile is converted in such a way that one or more aspects of the customer context profile may be presented to the customer 202 via the banking application the customer 202 is viewing. In this way, the banking application may be similar to a standard banking application, however it may have additional features, tabs, indicators, or the like specifically directed to the customer 202 based on the customer context profile associated with that customer 202.

Finally, as illustrated in block 810, the process 800 is completed by presenting one or more portions of the customer context profile to the customer 202 via the customer's online banking application. In this way, the customer context profile is converted in such a way that one or more aspects of the customer context profile may be presented to the customer 202 via the banking application the customer 202 is viewing. In this way, the banking application may be similar to a standard banking application, however it may have additional features, tabs, indicators, or the like specifically directed to the customer 202 based on the customer context profile associated with that customer 202.

As will be appreciated by one of ordinary skill in the art, the present invention may be embodied as an apparatus (including, for example, a system, a machine, a device, a computer program product, and/or the like), as a method (including, for example, a business process, a computer-implemented process, and/or the like), or as any combination of the foregoing. Accordingly, embodiments of the present invention may take the form of an entirely software embodiment (including firmware, resident software, micro-code, and the like), an entirely hardware embodiment, or an embodiment combining software and hardware aspects that may generally be referred to herein as a “system.” Furthermore, embodiments of the present invention may take the form of a computer program product that includes a computer-readable storage medium having computer-executable program code portions stored therein. As used herein, a processor may be “configured to” perform a certain function in a variety of ways, including, for example, by having one or more general-purpose circuits perform the functions by executing one or more computer-executable program code portions embodied in a computer-readable medium, and/or having one or more application-specific circuits perform the function.

It will be understood that any suitable computer-readable medium may be utilized. The computer-readable medium may include, but is not limited to, a non-transitory computer-readable medium, such as a tangible electronic, magnetic, optical, infrared, electromagnetic, and/or semiconductor system, apparatus, and/or device. For example, in some embodiments, the non-transitory computer-readable medium includes a tangible medium such as a portable computer diskette, a hard disk, a random access memory (RAM), a read-only memory (ROM), an erasable programmable read-only memory (EPROM or Flash memory), a compact disc read-only memory (CD-ROM), and/or some other tangible optical and/or magnetic storage device. In other embodiments of the present invention, however, the computer-readable medium may be transitory, such as a propagation signal including computer-executable program code portions embodied therein.

It will also be understood that one or more computer-executable program code portions for carrying out operations of the present invention may include object-oriented, scripted, and/or unscripted programming languages, such as, for example, Java, Perl, Smalltalk, C++, SAS, SQL, Python, Objective C, and/or the like. In some embodiments, the one or more computer-executable program code portions for carrying out operations of embodiments of the present invention are written in conventional procedural programming languages, such as the “C” programming languages and/or similar programming languages. The computer program code may alternatively or additionally be written in one or more multi-paradigm programming languages, such as, for example, F#.

It will further be understood that some embodiments of the present invention are described herein with reference to flowchart illustrations and/or block diagrams of systems, methods, and/or computer program products. It will be understood that each block included in the flowchart illustrations and/or block diagrams, and combinations of blocks included in the flowchart illustrations and/or block diagrams, may be implemented by one or more computer-executable program code portions. These one or more computer-executable program code portions may be provided to a processor of a general purpose computer, special purpose computer, and/or some other programmable data processing apparatus in order to produce a particular machine, such that the one or more computer-executable program code portions, which execute via the processor of the computer and/or other programmable data processing apparatus, create mechanisms for implementing the steps and/or functions represented by the flowchart(s) and/or block diagram block(s).

It will also be understood that the one or more computer-executable program code portions may be stored in a transitory or non-transitory computer-readable medium (e.g., a memory, and the like) that can direct a computer and/or other programmable data processing apparatus to function in a particular manner, such that the computer-executable program code portions stored in the computer-readable medium produce an article of manufacture, including instruction mechanisms which implement the steps and/or functions specified in the flowchart(s) and/or block diagram block(s).

The one or more computer-executable program code portions may also be loaded onto a computer and/or other programmable data processing apparatus to cause a series of operational steps to be performed on the computer and/or other programmable apparatus. In some embodiments, this produces a computer-implemented process such that the one or more computer-executable program code portions which execute on the computer and/or other programmable apparatus provide operational steps to implement the steps specified in the flowchart(s) and/or the functions specified in the block diagram block(s). Alternatively, computer-implemented steps may be combined with operator and/or human-implemented steps in order to carry out an embodiment of the present invention.

While certain exemplary embodiments have been described and shown in the accompanying drawings, it is to be understood that such embodiments are merely illustrative of, and not restrictive on, the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations and modifications of the just described embodiments can be configured without departing from the scope and spirit of the invention. Therefore, it is to be understood that, within the scope of the appended claims, the invention may be practiced other than as specifically described herein.

What is claimed is:

1. A system for providing a communication aid based on customer communications, the system comprising:
a memory device with computer-readable program code stored thereon;
a communication device;
a processing device operatively coupled to the memory device and the communication device, wherein the processing device is configured to execute the computer-readable program code to:
receive customer event data, wherein customer event data includes information about customer communications with a financial institution and information about transactions the customer made using a financial institution account;
analyze the received customer event data in real-time as the data is received, wherein analyzing the received customer event data includes applying logic to identify trends in customer communications;
determine, based on the received customer event data, one or more external life events for the customer, wherein the external life events are determined from a disposition of the customer communications with the financial institution and information associated with the products of the transaction using the financial institution account;
predict, based on the received customer event data and analysis of the received customer event data, one or more future customer communications, wherein the prediction is based on patterns of prior customer communications with the financial institution and prior transactions using the financial institution account;
generate, via a computer processing device, a customer context profile, wherein the customer context profile illustrates the trends in customer communications, the external life events of the customer, predicted future customer communications, and dispositions of previous customer communications; and
present the customer context profile to the appropriate communication channel.

2. The system of claim 1 further comprising providing opportunities for the customer within the financial institution and updating model logic based on received customer event data, wherein opportunities for the customer within the financial institution include offers and promotions based on prior customer communications with the financial institution and information about transactions the customer made using the financial institution account.

3. The system of claim 1, wherein receiving customer communication data further comprises receiving data regarding customer communications made with the financial institution or customer usage of the financial institution account in real-time as the communication or transaction is occurring, wherein customer communication data includes one or more of customer online communications, customer inquiry communications, customer transactions, account status of the customer, and customer status with the financial institution.

4. The system of claim 1, wherein receiving customer communication data further comprises receiving data regarding customer communications made with the financial institution or customer usage of the financial institution account in real-time from one or more communication channels associated with the financial institution or from merchants associated with the transaction, wherein communication channels associated with the financial institution includes online or mobile banking websites or applications, branch locations, or automatic teller machine (ATM).

5. The system of claim 1, wherein presenting the customer context profile to the appropriate communication channel further comprises authenticating the customer associated with the customer context profile prior to presenting the customer context profile to the appropriate communication channel, the authentication occurs via geo-fence identification, personal identification number (PIN), magnetic strip swiping of financial institution card, or password authentication.

6. The system of claim 1, wherein the customer context profile provides an interface which includes information about recent customer events, accounts the customer has with the financial institution, opportunities or offers available to the customer from the financial institution, customer status information, and financial institution solutions for the customer communications.

7. The system of claim 1, wherein the customer context profile is adapted to each of the one or more communication channels.

8. The system of claim 7, wherein the customer context profile is adapted to be presented to an agent at a communication channel associated with the financial institution, when the customer communicates with the communication channel, such that the agent has immediate access to information about recent customer events, accounts the customer has with the financial institution, opportunities or offers available to the customer from the financial institution, customer status information, and financial institution solutions for the customer communications.

9. The system of claim 7, wherein the customer context profile is adapted to be integrated into an online or mobile application of the customer, such that the customer has access to information about recent customer events, accounts the customer has with the financial institution, opportunities or offers available to the customer from the financial institution, customer status information, and financial institution solutions for the customer communications adapted for customer viewing.

10. A computer program product for providing a communication aid based on customer communications, the computer program product comprising at least one non-transitory computer-readable medium having computer-readable program code portions embodied therein, the computer-readable program code portions comprising:
an executable portion configured for receiving customer event data, wherein customer event data includes information about customer communications with a financial institution and information about transactions the customer made using a financial institution account;
an executable portion configured for analyzing the received customer event data in real-time as the data is received, wherein analyzing the received customer event data includes applying logic to identify trends in customer communications;
an executable portion configured for determining, based on the received customer event data, one or more external life events for the customer, wherein the external life events are determined from a disposition of the customer communications with the financial institution and information associated with the products of the transaction using the financial institution account;
an executable portion configured for predicting, based on the received customer event data and analysis of the received customer event data, one or more future customer communications, wherein the prediction is based on patterns of prior customer communications with the financial institution and prior transactions using the financial institution account;
an executable portion configured for generating a customer context profile, wherein the customer context profile illustrates the trends in customer communications, the external life events of the customer, predicted future customer communications, and dispositions of previous customer communications; and
an executable portion configured for presenting the customer context profile to the appropriate communication channel.

11. The computer program product of claim 10, further comprising an executable portion configured for providing opportunities for the customer within the financial institution and updating model logic based on received customer event data, wherein opportunities for the customer within the financial institution include offers and promotions based on prior customer communications with the financial institution and information about transactions the customer made using the financial institution account.

12. The computer program product of claim 10, wherein receiving customer communication data further comprises receiving data regarding customer communications made with the financial institution or customer usage of the financial institution account in real-time as the communication or transaction is occurring, wherein customer communication data includes one or more of customer online communications, customer inquiry communications, customer transactions, account status of the customer, and customer status with the financial institution.

13. The computer program product of claim 10, wherein receiving customer communication data further comprises receiving data regarding customer communications made with the financial institution or customer usage of the financial institution account in real-time from one or more communication channels associated with the financial institution or from merchants associated with the transaction, wherein communication channels associated with the financial institution includes online or mobile banking websites or applications, branch locations, or automatic teller machine (ATM).

14. The computer program product of claim 10, wherein presenting the customer context profile to the appropriate communication channel further comprises authenticating the customer associated with the customer context profile prior to presenting the customer context profile to the appropriate communication channel, the authentication occurs via geo-fence identification, personal identification number (PIN), magnetic strip swiping of financial institution card, or password authentication.

15. The computer program product of claim 10, wherein the customer context profile provides an interface which includes information about recent customer events, accounts the customer has with the financial institution, opportunities or offers available to the customer from the financial institution, customer status information, and financial institution solutions for the customer communications.

16. The computer program product of claim 10, wherein the customer context profile is adapted to each of the one or more communication channels.

17. The computer program product of claim 16, wherein the customer context profile is adapted to be presented to an agent at a communication channel associated with the financial institution, when the customer communicates with the communication channel, such that the agent has immediate access to information about recent customer events, accounts the customer has with the financial institution, opportunities or offers available to the customer from the financial institution, customer status information, and financial institution solutions for the customer communications.

18. The computer program product of claim 16, wherein the customer context profile is adapted to be integrated into an online or mobile application of the customer, such that the customer has access to information about recent customer events, accounts the customer has with the financial institution, opportunities or offers available to the customer from the financial institution, customer status information, and financial institution solutions for the customer communications adapted for customer viewing.

19. A computer-implemented method for providing a communication aid based on customer communications, the method comprising:
providing a computing system comprising a computer processing device and a non-transitory computer readable medium, where the computer readable medium comprises configured computer program instruction code, such that when said instruction code is operated by said computer processing device, said computer processing device performs the following operations:
receiving customer event data, wherein customer event data includes information about customer communications with a financial institution and information about transactions the customer made using a financial institution account;
analyzing the received customer event data in real-time as the data is received, wherein analyzing the received customer event data includes applying logic to identify trends in customer communications;
determining, based on the received customer event data, one or more external life events for the customer, wherein the external life events are determined from a disposition of the customer communications with the financial institution and information associated with the products of the transaction using the financial institution account;
predicting, based on the received customer event data and analysis of the received customer event data, one or more future customer communications, wherein the prediction is based on patterns of prior customer communications with the financial institution and prior transactions using the financial institution account;
generating, via a computer processing device, a customer context profile, wherein the customer context profile illustrates the trends in customer communications, the external life events of the customer, predicted future customer communications, and dispositions of previous customer communications; and
presenting the customer context profile to the appropriate communication channel.

20. The computer-implemented method of claim 19 further comprising providing opportunities for the customer within the financial institution and updating model logic based on received customer event data, wherein opportunities for the customer within the financial institution include offers and promotions based on prior customer communications with the financial institution and information about transactions the customer made using the financial institution account.

21. The computer-implemented method of claim 19, wherein receiving customer communication data further comprises receiving data regarding customer communications made with the financial institution or customer usage of the financial institution account in real-time as the communication or transaction is occurring, wherein customer communication data includes one or more of customer online communications, customer inquiry communications, customer transactions, account status of the customer, and customer status with the financial institution.

22. The computer-implemented method of claim 19, wherein receiving customer communication data further comprises receiving data regarding customer communications made with the financial institution or customer usage of the financial institution account in real-time from one or more communication channels associated with the financial institution or from merchants associated with the transaction, wherein communication channels associated with the financial institution includes online or mobile banking websites or applications, branch locations, or automatic teller machine (ATM).

23. The computer-implemented method of claim 19, wherein presenting the customer context profile to the appropriate communication channel further comprises authenticating the customer associated with the customer context profile prior to presenting the customer context profile to the appropriate communication channel, the authentication occurs via geo-fence identification, personal identification number (PIN), magnetic strip swiping of financial institution card, or password authentication.

24. The computer-implemented method of claim 19, wherein the customer context profile provides an interface which includes information about recent customer events, accounts the customer has with the financial institution, opportunities or offers available to the customer from the financial institution, customer status information, and financial institution solutions for the customer communications.

25. The computer-implemented method of claim 19, wherein the customer context profile is adapted to each of the one or more communication channels.
